(19) United States
(12) Patent Application Publication
(10) Pub. No.: US 2005/0243067 A1
(43) Pub. Date: Nov. 3, 2005

(54) Method and system providing for keyboard navigation of a displayable representation of connectable objects

(75) Inventors: Mark S. Anspach, Wellington, CO (US); Evelyn L. Williams, Longmont, CO (US); Michael D. Renfro, Windsor, CO (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(73) Assignee: Hewlett-Packard Development Company, L.P., Houston, TX (US)

(21) Appl. No.: 11/117,319

(22) Filed: Apr. 29, 2005

Related U.S. Application Data
(60) Provisional application No. 60/566,608, filed on Apr. 30, 2004.

(51) Int. Cl. G09G 5/00

(52) U.S. Cl. 345/172

(57) ABSTRACT

A method and system are described of providing for keyboard navigation of a displayable representation of connectable objects. According to an exemplary embodiment, a method of providing for keyboard navigation of a displayable representation of connectable objects includes assigning keystrokes to provide for separately traversing a plurality of connectable objects included in the displayable representation, a plurality of connectors associated with an object, and a link between respective connectors of a pair of connected objects. Each traversal proceeds according to a respective predetermined sequence. The method includes detecting one of the assigned keystrokes. A location cursor is associated with one element of the group of objects, connectors, and link based on an existing association of the location cursor with one of the elements when the keystroke is detected and the predetermined sequence associated with the detected keystroke.

### BACKGROUND

Software tools for displaying program objects typically present a simple table or listing of objects and their attributes to a user without presenting additional information, such as how the displayed objects relate to one another. Many such tools also present only a “flat” representation of the objects that exist at a particular level of the program data hierarchy. These objects are often presented in a grid format, such as the file listings provided by file explorer programs.

The models used to provide keyboard navigation with such grid-layout tools can be simple as well. For example, the Page-Up, Page-Down, Home, End and Arrow keys can be assigned to move a location cursor between the objects as they are presented in the grid layout. Other keyboard navigation models assign the Arrow and/or Tab keys to allow a user to traverse sequentially through a set of displayable elements until reaching a particular element for interaction. Such keyboard navigation models can limit a user's ability to traverse alternate navigation paths through the elements, for example based on properties of the elements being navigated or their relationships.

Some software products are capable of displaying complex relationships among the objects included in their databases. An example is network management software, such as Hewlett Packard's OpenView product. Network management software is capable of presenting properties of the managed objects and other relationships, such as object dependency and connectivity, in graphical network topology maps. Like the object display tools described above, network management software tools typically rely on mouse navigation or on Arrow and Tab keys that only allow a user to traverse sequentially through all elements in the map, regardless of their type or relationship. This type of keyboard navigation can be limiting in navigating topology maps because it can hinder a users' ability to navigate particular paths or linkages included in the map.

Navigational models that rely on a grid layout often do not work well with network management software either, as the objects displayed in the topology maps can rarely be fitted to a grid. Moreover, such navigational models can still require that a user traverse through every element displayed in the map to reach a desired element. It can be advantageous to provide users with the ability to navigate through the objects based on a task context. For example, a user may wish to navigate a communication path between objects regardless of the position of the objects in the graphical layout. In addition, the elements presented in a topology map can be of different types and can exist at different hierarchical levels in the network topology. These characteristics can be presented in the topology map using different graphical symbols, such as node symbols, connectors, and links. It can be advantageous to provide users with the ability to independently navigate a topology map in a non-sequential or non-linear manner through the different paths defined by each of these elements.

A robust keyboard interface can be an important navigational instrument when users are operating software with limited hardware resources, or where the user has some type of disability. For example, a mouse may not be available or practical for use with applications that are capable of displaying complex graphical representations of object topologies using mobile electronic equipment, such as telephones or personal digital assistants (PDAs). Also, users having a physical impairment can require voice activation software that typically utilizes a keyboard navigation interface to control the operation of its software. Moreover, users having a vision impairment can require screen reader tools that also rely on the keyboard navigation interface to control their operation. Recently enacted legislation requires that software meet certain accessibility requirements (for example, Section 508 of the Rehabilitation Act of 1998). An important mechanism to enable software to meet these standards can be a more robust keyboard navigation model that is capable of interfacing with assistive technologies, such as the voice recognition and screen reader software tools mentioned above.

### SUMMARY

Accordingly, a method and system are disclosed of providing for keyboard navigation of a displayable representation of connectable objects. According to an exemplary embodiment, a method of providing for keyboard navigation of a displayable representation of connectable objects includes assigning keystrokes to provide for separately traversing a plurality of connectable objects included in the displayable representation, a plurality of connectors associated with an object, and a link between respective connectors of a pair of connected objects. Each traversal proceeds according to a respective predetermined sequence. The method includes detecting one of the assigned keystrokes. A location cursor is associated with one element of the group of objects, connectors, and link based on an existing association of the location cursor with one of the elements when the keystroke is detected and the predetermined sequence associated with the detected keystroke.

According to another exemplary embodiment, a system is described of providing for keyboard navigation of a displayable representation of connectable objects. The system includes a monitor configured to display the representation of connectable objects. A computer keyboard is configured to generate signals corresponding to keystrokes entered on the keyboard. The system includes a processor coupled to the monitor and keyboard. The processor includes logic configured to assign keystrokes to provide for separately traversing a plurality of connectable objects included in the displayable representation, a plurality of connectors associated with an object, and a link between respective connectors of a pair of connected objects. Each traversal proceeds according to a respective predetermined sequence. Additional logic is configured to detect one of the assigned keystrokes entered on the keyboard. Logic is also configured in the processor to associate a location cursor with one element of the group of objects, connectors, and link based on an existing association of the location cursor with one of the elements when the keystroke is detected and the predetermined sequence associated with the detected keystroke.

### BRIEF DESCRIPTION OF THE DRAWINGS

The accompanying drawings provide visual representations which will be used to more fully describe the representative embodiments disclosed here and can be used by those skilled in the art to better understand them and their inherent advantages. In these drawings, like reference numerals identify corresponding elements, and:

FIG. 1 is a flowchart illustrating a method of providing for keyboard navigation of a displayable representation of connectable objects, according to an exemplary embodiment; and

FIG. 2 illustrates a system of providing for keyboard navigation of a displayable representation of connectable objects, according to an exemplary embodiment.

### DETAILED DESCRIPTION

Various aspects are described here in connection with exemplary embodiments, including certain aspects described in terms of sequences of actions that can be performed by elements of a computer system. For example, it will be recognized that in each of the embodiments, various actions can be performed by specialized circuits or circuitry (for example, discrete and/or integrated logic gates interconnected to perform a specialized function), by program instructions being executed by one or more processors, or by a combination of both. Thus, the various aspects can be embodied in many different forms, and all such forms are contemplated to be within the scope of what is described. For each of the various aspects, any such form of embodiment can be referred to here as “logic configured to” perform, or “logic that” performs a described action.

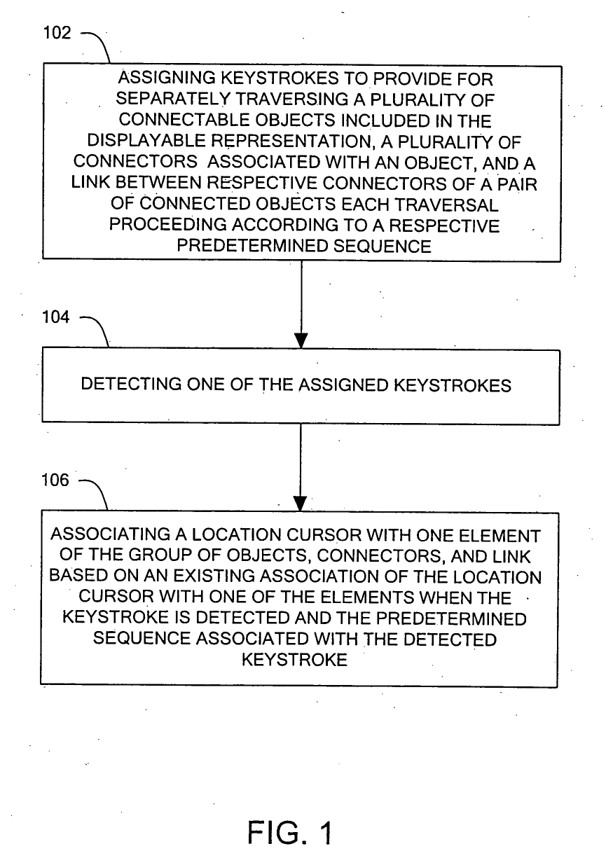

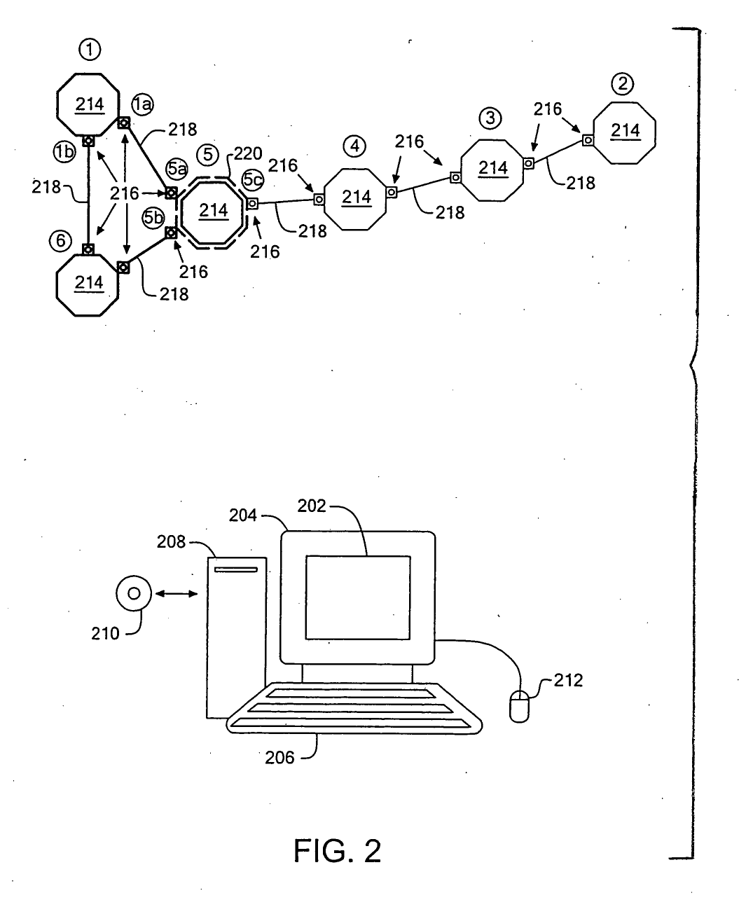

FIG. 1 depicts a flowchart illustrating an exemplary method of providing for keyboard navigation of a displayable representation of connectable objects. The method can be carried out using the exemplary system depicted in FIG. 2. FIG. 2 depicts a topology diagram 202 of connected nodes operating in a network. The objects 214 can represent nodes in the network, such as routers and switches. The connectors 216 can represent networks ports included in the nodes. The links 218 can represent network links, such as ATM or Ethernet links. Network topology diagrams can be generated using network management software programs, such as Hewlett Packard's OpenView product. While the techniques described here are illustrated using the network topology diagram 202 shown in FIG. 2, it will be understand that these techniques can be applied to any displayable representation of connectable objects, such as tables, listings, and other types of diagrams that can include representations of physically and/or logically connectable objects.

In block 102 of the exemplary method, keystrokes are assigned to provide for separately traversing a plurality of connectable objects included in the displayable representation, a plurality of connectors associated with an object, and a link between respective connectors of a pair of connected objects. For example, FIG. 2 shows a representation 202 of connectable objects 214 that can be displayed using display means, such as the monitor 204 shown in the figure. The connectable objects 214 can each include a number of connectors 216. The connectable objects 214 can be coupled to one another using links 218. The links 218 can extend from respective connectors 216 on the coupled objects 214. Means for assigning the keystrokes can include a processor 208, such as the CPU shown in the figure. The processor 208 can include logic and/or software that can be configured to dynamically assign different keystrokes for controlling the execution of corresponding code modules to provide for separately traversing the objects, connectors, and link.

By assigning keystrokes to provide for separately traversing the objects, connectors, and link, a user can efficiently navigate through one type of element (for example, objects) included in the representation, without having to also navigate through the other types of elements (for example, connectors and links) included in the representation. Each traversal through a particular type of element included in the representation proceeds according to a respective predetermined sequence associated with that element type. Consequently, a user can navigate through all of the elements included in the representation in a non-sequential or non-linear manner. The predetermined sequence can be determined dynamically by the processor 208, or can be stored in system memory (not shown) and then referenced by the processor 208.

In block 104 of the method, one of the assigned keystrokes is detected. For example, means for generating signals corresponding to keystrokes, such as the computer keyboard 206 shown in FIG. 2, can be configured to generate signals corresponding to keystrokes entered by a user on the keyboard 206. The keyboard 206 can be coupled to the processor 208. Means for detecting the keystrokes can include logic and/or software included in the processor 208. This logic and/or software can be configured to detect and decode the keystrokes entered on the keyboard. The design of such keyboards and decode logic is known to those skilled in the art, and will not be discussed here in detail. The signals corresponding to the detected keystrokes can be used to control the operation of software executing on the processor 208, similar to the control signals generated by other types of input devices, such as the mouse 212 shown in the figure.

In block 106, a location cursor is associated with one element of the group of objects, connectors, and link. The location cursor can be a visual cue, such as the dashed outline shape 220 shown as surrounding the fifth connectable object 214 (identified by the circled numeral 5) in FIG. 2. “Visual cues”, as used herein, can include any visual attribute of the representation 202 that can be used to distinguish the one element associated with the location cursor 220 from other elements in the representation 202. Visual attributes can include relative positioning, for example, among information presented in a table (indenting, tabbing, hierarchical listings); color (foreground and background); font; orientation; shading; graphics (3D); and text attribute (underlining, italics, bold, case). Other visual attributes can include additional text (labels, headers, footers, footnotes, reference indices) and symbols that can be included in the representation 202 to identify the element associated with the location cursor. It will be understood that the exemplary lists of visual cues provided are not exhaustive.

The element associated with the location cursor in block 106 is both based on (1) an existing association of the location cursor with one of the elements when the keystroke is detected, and (2) the predetermined sequence associated with the element type through which the detected keystroke is assigned to traverse. According to an exemplary embodiment, when the detected keystroke is assigned to provide for traversing a plurality of connectable objects, the location cursor can be associated with one of a next object, a previous object, a first object, and a last object in a left-to-right, top-to-bottom sequence of the connectable objects. Persons skilled in the art will understand that a left-to-right, top-to-bottom sequence is consistent with the manner in which the English language is written and read. Means for associating the location cursor with the one element can include the processor 208 and monitor 204. For example, the processor 208 can include logic and/or software to determine the element to be associated with the location cursor 220 based on the existing association of the location cursor 220 and the predetermined sequence associated with the detected keystroke. The processor 208 can then be configured to add a visual cue to the representation 202 displayable on the monitor 204 to reflect the new association of the location cursor 220.

The objects 214 shown in FIG. 2 are numbered in the figure according to a left-to-right, top-to-bottom sequence. The first object 214 in the sequence is the left-most, top-most object identified by the circled numeral 1. Similarly, the last object 214 in the sequence is the right-most, bottom-most object identified by the circled numeral 6. The next and previous objects 214 are determined based on the relative positioning of the objects 214 in the representation 202. To avoid ambiguity in the sequencing, a particular location on the objects 214 can be used as a reference point to determine their position relative to other objects 214 in the representation 202.

For example, the left-most point on each object 214 can be used to determine the relative left-to-right position of the object in the sequence, and the top-most point on each object 214 can be used to determine the relative top-to-bottom position of the object. Imaginary lines can be drawn extending vertically from the left-most points on the objects 214 to determine the relative left-to-right sequence, and drawn extending horizontally from the top-most points on the objects 214 to determine the relative top-to-bottom sequence. Objects intersecting a same imaginary line can be considered positionally equivalent in the corresponding left-to-right or top-to-bottom sequence. Applying this technique to the objects 214 shown in FIG. 2, the objects 214 are ordered 1-6 as identified by the circled numerals included in the figure. Other sequences, such as a top-to-bottom, left-to-right sequence can be associated with traversing the plurality of connectable objects. Such a sequence would result in the objects being traversed in the order 1-6-5-4-3-2.

The next and previous objects 214 can be positioned in the representation 202 relative to a position of the element associated with the location cursor when the keystroke is detected. Again, a particular location on the element associated with the location cursor when the keystroke is detected can be used to determine which object is the “next” or “previous” object in the left-to-right, top-to-bottom sequence of objects 214 included in the representation 202. For example, the midpoint or center of a connector 216 or link 218 can be used as a reference point to determine their position relative to the objects 214 included the representation 202. The object 214 nearest to the right or below the reference point of the connector 216 or link 218 can be the “next” object in the sequence, and the object 214 nearest to the left or above the reference point of the connector 216 or link 218 can be the “previous” object in the sequence.

The detected keystroke assigned to provide for associating the location cursor with the next object in the sequence can include the Page-Down key or a Tab key. The detected keystroke assigned to provide for associating the location cursor with the previous object in the sequence can include the Page-Up key or a Shift-Tab key (simultaneously activating the Shift and Tab keys). The detected keystroke assigned to provide for associating the location cursor with the first object in the sequence can include the Home key. Similarly, the detected keystroke assigned to provide for associating the location cursor with the last object in the sequence can include the End key. For example, consider an arrangement in which the location cursor 220 is associated with the fourth object 214 in the representation 202 (the object identified by the circled numeral 4). Separately activating the Page-Down (or Tab), Page-Up (or Shift-Tab), Home, and End keys can result in the location cursor 202 being associated with the fifth, third, first, and sixth objects 214 (as identified by the circled numerals), respectively.

According to another exemplary embodiment, when the detected keystroke is assigned to provide for traversing a plurality of connectable objects and the element associated with the location cursor when the keystroke is detected is a connector, the location cursor can be associated with an object that includes the connector corresponding to the element associated with the location cursor when the keystroke is detected. For example, consider an arrangement in which the location cursor 220 is associated with the connector 216 identified by circled alpha-numeric 5a. When the detected keystroke is assigned to provide for traversing the objects 214 (e.g., the detected keystroke includes the Page-Up key), the location cursor 220 is associated with the fifth object 214 (identified by the circled numeral 5) that includes the connector 216 labeled 5a.

According to a related embodiment, the detected keystroke assigned to provide for associating the location cursor with the object that includes the connector can include any of the Page-Down key, the Page-Up key, the Tab Key, or the Shift-Tab key. Thus, rather than the location cursor 220 being associated with the first or “previous” object 214 (identified by the circled numeral 1) nearest to the left or above the reference point of the connector 216 labeled 5a when, for example, the Page-Up key is detected, the location cursor 220 can instead be associated with the fifth object 214 that includes the connector 216 labeled Sa. With such an arrangement, it can be advantageous to assign the Home and End keys to still provide for associating the location cursor 220 with the first and last objects 214 in the sequence.

According to another exemplary embodiment, when the detected keystroke is assigned to provide for traversing a plurality of connectors associated with an object, the location cursor can be associated with a connector in a perimetrical sequence of the connectors associated with the object based on whether the element associated with the location cursor when the keystroke is detected corresponds to the object or to a connector associated with the object. By “perimetrical” it is meant that the traversal proceeds through the connectors 216 located along the perimeter of a connection boundary of the object 214. Persons skilled in the art will understand that this connection boundary need not be the outer perimeter of the object 214 or even be a closed shape. For example, the connection boundary could be a straight line through the center of an object 214, in which case a “perimetrical” sequence would traverse through the connectors located along the straight line.

According to a related embodiment, when the element associated with the location cursor when the keystroke is detected corresponds to the object, the location cursor can be associated with a first connector in the sequence. The first connector can be positioned in the representation nearest a top-most portion of the object. For example, consider the arrangement shown in FIG. 2 in which the location cursor 220 is associated with the fifth object 214. When the keystroke assigned to provide for traversing the connectors 216 associated with the fifth object is detected, the location cursor 220 can be associated with (and repositioned over) the connector 216 labeled 5a, which is positioned nearest a top-most portion of the fifth object. The detected keystroke assigned to provide for associating the location cursor with the first connector in the sequence can include a Right-Arrow key or a Left-Arrow key. Thus, when the location cursor 220 is associated with the fifth object 214 and a user activates either Right or Left arrow keys, the location cursor can be associated with (and repositioned over) the top-most connector 216 labeled 5a. In this way, a user can “jump” in a non-linear manner from the fifth object 214 to the connector 216 labeled 5a.

According to another exemplary embodiment, when the element associated with the location cursor when the keystroke is detected corresponds to the connector associated with the object, the location cursor can be associated with one of a next connector and a previous connector in the sequence. The next and previous connectors can be respectively positioned clockwise and counterclockwise in the perimetrical sequence relative to a position in the representation of the connector associated with the object. The detected keystroke assigned to provide for associating the location cursor with the next (or clockwise-located) connector in the sequence can include the Right-Arrow key. The detected keystroke assigned to provide for associating the location cursor with the previous (or counterclockwise-located) connector in the sequence can include the Left-Arrow key.

For example, consider the arrangement above in which the location cursor 220 has been associated with the first connector 216 labeled 5a. When a Right-arrow key is detected, the location cursor 220 can be associated with the next connector positioned clockwise in the sequence relative to the position of the connector 216 labeled 5a, or the connector 216 labeled 5c in the representation 202. Similarly, when a Left-arrow key is detected, the location cursor 220 can be associated with the previous connector positioned counterclockwise in the sequence relative to the position of the connector 216 labeled 5a, or the connector 216 labeled 5b in representation 202. Persons skilled in the art will understand that the terms clockwise and counterclockwise when applied to non-circular objects correspond to moving along the perimeter of an object in the left-to-right, top-to-bottom and right-to-left, top-to-bottom directions, respectively.

According to another exemplary embodiment, when the detected keystroke is assigned to provide for traversing a plurality of connectors associated with an object and the element associated with the location cursor when the keystroke is detected is a link between respective connectors of a pair of connected objects, the location cursor can be associated with one of a first of the respective connectors, positioned in the representation either to the right of or below a center of the link, and a second of the connectors, positioned either to the left of or above the center of the link. The detected keystroke assigned to provide for associating the location cursor with the first connector can include the Right-Arrow key and the detected keystroke assigned to provide for associating the location cursor with the second connector can include the Left-Arrow key.

For example, consider an arrangement in which the location cursor 220 is associated with the link 218 between the connectors labeled 1a and 5a of the pair of first and fifth connected objects 214 (identified by the circled numerals 1 and 5, respectively) included in the representation 202. When a Right-arrow key is detected, the location cursor 220 can be associated with the first of the respective connectors 216 positioned in the representation 202 either to the right of or below the center of the link 218, or the connector 216 labeled 5a in the representation 202. Similarly, when a Left-arrow key is detected, the location cursor 220 can be associated with the second of the respective connectors 216 positioned in the representation 202 either to the left of or above the center of the link 218, or the connector 216 labeled 1a in the representation 202.

According to another exemplary embodiment, when the detected keystroke is assigned to provide for traversing a link between respective connectors of a pair of connected objects, the location cursor can be associated with the link when the element associated with the location cursor when the keystroke is detected corresponds to one of the respective connectors. The detected keystroke assigned to provide for associating the location cursor with the link can include an Up-Arrow key or a Down-Arrow key. For example, consider an arrangement in which the location cursor 220 is associated with the connector 216 labeled 5a in FIG. 2. When either the Up or Down arrow keys is detected, the location cursor 220 can be associated with (and repositioned over) the link 218 between the respective connectors labeled 1a and 5a of the pair of first and fifth connected objects 214 (identified by the circled numerals 1 and 5, respectively) included in the representation 202. In this way, a user can “jump” in a non-linear manner from the connector 216 labeled 5a to the link 218 between the first and fifth connected objects 214.

According to a related embodiment, when the detected keystroke is assigned to provide for traversing a link between respective connectors of a pair of connected objects, the location cursor can be associated with one of the respective connectors when the element associated with the location cursor when the keystroke is detected corresponds to the link. In a preferred related embodiment, a same keystroke assigned to provide for associating the location cursor with the link can also be assigned to provide for associating the location cursor with the other of the respective connectors.

For example, consider an arrangement in which the location cursor 220 is associated with the link 218 between the connectors labeled 1a and 5a of the pair of first and fifth connected objects 214 included in the representation 202. Further, consider that the Up-Arrow key was assigned to provide for associating location cursor 202 with the link 218 after being previously associated with (and positioned over) one of the respective connectors 216 labeled 5a in the representation 202. The same Up-Arrow key can be assigned to provide for associating the location cursor with the other of the respective connectors labeled 1a in the representation 202. In this way, a user can first “jump” in a non-linear manner from the connector 216 labeled 5a to the link 218 between the first and fifth connected objects 214 using a particular keystroke, for example the Up-Arrow key. The user can then traverse the link 218 to the other connector 216 labeled 1a associated with the link 218 using the same Up-Arrow key.

According to another exemplary embodiment, respective pairs of keystrokes can be assigned to provide for separately traversing the plurality of connectable objects, the plurality of connectors, and the link. A first keystroke of a respective pair of keystrokes can correspond to the detected keystroke assigned to provide for associating the location cursor with the one element of the group of objects, connectors, and link, and a second keystroke of the respective pair can be assigned to provide for re-associating the location cursor with the element associated with the location cursor when the keystroke is detected.

For example the Page-Up and Page-Down keys can be assigned in a pair to provide for traversing the plurality connectable objects 214. Similarly, the Right-Arrow and Left-Arrow keys can be assigned in a pair to provide for traversing the plurality of connectors 216. Likewise, the Up-Arrow and Down-Arrow keys can be assigned in a pair to provide for traversing the link 218. In this way, a user can use one of the keystrokes in a pair to navigate through a sequence of a particular type of elements (for example, objects 214) in a first direction, and can use the opposite or complementary keystroke in the pair to navigate to the previous element in the sequence and to continue navigating through the sequence of elements in an opposite direction. The activation of an opposite or complementary keystroke can be configured to provide for associating the location cursor with a previous element after a non-linear “jump” between element types has occurred. But preferably the detection of a complementary key after such a non-linear “jump” has occurred will not be used to return to the element previously associated with the location cursor to avoid confusion.

According to an exemplary embodiment, a keystroke can be assigned to provide for selecting the one element of the group of objects, connectors, and link associated with the location cursor. For example, a Space key can be assigned to provide for selecting an element. The selection can be indicated using visual cues, such as the highlighting associated with the first, fifth, and sixth objects 214 shown in FIG. 2 and the connectors 216 and links 218 connecting those objects. Persons skilled in the art will understand that additional keystrokes can be combined with the Space key, for example, the Shift and Control keys, to provide for sequenced and non-sequenced multiple selection of objects. A keystroke can also be assigned to provide for performing an action on the one element of the group of objects, connectors, and link associated with the location cursor. For example, the Enter key can be assigned to perform an action, such as displaying the properties of a selected object, connector, or link, when detected. The action can be a “default” action, pre-determined from any number of actions that can be performed on the one element of the group of objects, connectors, and link associated with the location cursor.

The executable instructions of a computer program as illustrated in FIG. 1 of providing for keyboard navigation of a displayable representation of connectable objects can be embodied in any computer readable medium for use by or in connection with an instruction execution system, apparatus, or device, such as a computer based system, processor containing system, or other system that can fetch the instructions from the instruction execution system, apparatus, or device and execute the instructions.

As used here, a “computer readable medium” can be any means that can contain, store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium, such as the removable storage device 210 shown in FIG. 2. More specific examples (a non exhaustive list) of the computer readable medium can include the following: an electrical connection having one or more wires, a portable computer diskette, a random access memory (RAM), a read only memory (ROM), an erasable programmable read only memory (EPROM or Flash memory), an optical fiber, and a portable compact disc read only memory (CDROM).

It will be appreciated by those of ordinary skill in the art that the concepts and techniques described here can be embodied in various specific forms without departing from the essential characteristics thereof. The presently disclosed embodiments are considered in all respects to be illustrative and not restrictive. The scope of the invention is indicated by the appended claims, rather than the foregoing description, and all changes that come within the meaning and range of equivalence thereof are intended to be embraced.

1. A method of providing for keyboard navigation of a displayable representation of connectable objects, the method comprising:
assigning keystrokes to provide for separately traversing a plurality of connectable objects included in the displayable representation, a plurality of connectors associated with an object, and a link between respective connectors of a pair of connected objects, each traversal proceeding according to a respective predetermined sequence;
detecting one of the assigned keystrokes; and
associating a location cursor with one element of the group of objects, connectors, and link based on an existing association of the location cursor with one of the elements when the keystroke is detected and the predetermined sequence associated with the detected keystroke.

2. The method of claim 1, wherein when the detected keystroke is assigned to provide for traversing a plurality of connectable objects, the method comprises:
associating the location cursor with one of a next object, a previous object, a first object, and a last object in a left-to-right, top-to-bottom sequence of the connectable objects, the next and previous objects positioned in the representation relative to a position of the element associated with the location cursor when the keystroke is detected.

3. The method of claim 2, wherein the detected keystroke assigned to provide for associating the location cursor with the next, previous, first, and last objects in the sequence respectively comprises:
a Page-Down key or a Tab key;
a Page-Up key or a Shift-Tab key;
a Home key; and
an End key.

4. The method of claim 1, wherein when the detected keystroke is assigned to provide for traversing a plurality of connectable objects and the element associated with the location cursor when the keystroke is detected is a connector, the method comprises:
associating the location cursor with an object that includes the connector corresponding to the element associated with the location cursor when the keystroke is detected.

5. The method of claim 4, wherein the detected keystroke assigned to provide for associating the location cursor with the object that includes the connector comprises a Page-Down key, a Page-Up key, a Tab Key, or a Shift-Tab key.

6. The method of claim 1, wherein when the detected keystroke is assigned to provide for traversing a plurality of connectors associated with an object, the method comprises:
associating the location cursor with a connector in a perimetrical sequence of the connectors associated with the object based on whether the element associated with the location cursor when the keystroke is detected corresponds to the object or to a connector associated with the object.

7. The method of claim 6, wherein when the element associated with the location cursor when the keystroke is detected corresponds to the object, the method comprises:
associating the location cursor with a first connector in the sequence, the first connector positioned in the representation nearest a top-most portion of the object.

8. The method of claim 7, wherein the detected keystroke assigned to provide for associating the location cursor with the first connector in the sequence comprises a Right-Arrow key or a Left-Arrow key.

9. The method of claim 6, wherein when the element associated with the location cursor when the keystroke is detected corresponds to the connector associated with the object, the method comprises:
associating the location cursor with one of a next connector and a previous connector in the sequence, the next and previous connectors respectively positioned clockwise and counterclockwise in the sequence relative to a position in the representation of the connector associated with the object.

10. The method of claim 9, wherein the detected keystroke assigned to provide for associating the location cursor with the next connector in the sequence comprises a Right-Arrow key and the detected keystroke assigned to provide for associating the location cursor with the previous connector in the sequence comprises a Left-Arrow key.

11. The method of claim 1, wherein when the detected keystroke is assigned to provide for traversing a plurality of connectors associated with an object and the element associated with the location cursor when the keystroke is detected is a link between respective connectors of a pair of connected objects, the method comprises:
associating the location cursor with one of a first of the respective connectors, positioned in the representation either to the right of or below a center of the link, and a second of the connectors, positioned either to the left of or above the center of the link.

12. The method of claim 11, wherein the detected keystroke assigned to provide for associating the location cursor with the first connector comprises a Right-Arrow key and the detected keystroke assigned to provide for associating the location cursor with the second connector comprises a Left-Arrow key.

13. The method of claim 1, wherein when the detected keystroke is assigned to provide for traversing a link between respective connectors of a pair of connected objects, the method comprises:
associating the location cursor with one of the respective connectors when the element associated with the location cursor when the keystroke is detected corresponds to the link, and with the link when the element associated with the location cursor when the keystroke is detected corresponds to one of the respective connectors.

14. The method of claim 13, wherein when the element associated with the location cursor when the keystroke is detected corresponds to one of the respective connectors, the detected keystroke assigned to provide for associating the location cursor with the link comprises an Up-Arrow key or a Down-Arrow key.

15. The method of claim 14, wherein when the location cursor is associated with the link, the method comprises:
assigning a same keystroke assigned to provide for associating the location cursor with the link to provide for associating the location cursor with the other of the respective connectors.

16. The method of claim 1, comprising:
assigning respective pairs of keystrokes to provide for separately traversing the plurality of connectable objects, the plurality of connectors, and the link;
wherein a first keystroke of a respective pair of keystrokes corresponds to the detected keystroke assigned to provide for associating the location cursor with the one element of the group of objects, connectors, and link, and a second keystroke of the respective pair is assigned to provide for re-associating the location cursor with the element associated with the location cursor when the keystroke is detected.

17. The method of claim 1, comprising:
assigning a keystroke to provide for selecting the one element of the group of objects, connectors, and link associated with the location cursor; and
assigning a keystroke to provide for performing an action on the one element of the group of objects, connectors, and link associated with the location cursor.

18. The method of claim 17, wherein the keystroke assigned to provide for selecting the one element comprises a Space-Bar key, and the keystroke assigned to provide for performing an action on the one element comprises an Enter key.

19. A system of providing for keyboard navigation of a displayable representation of connectable objects, the system comprising:
a monitor configured to display the representation of connectable objects;
a computer keyboard configured to generate signals corresponding to keystrokes entered on the keyboard; and
a processor coupled to the monitor and keyboard, the processor including:
logic configured to assign keystrokes to provide for separately traversing a plurality of connectable objects included in the displayable representation, a plurality of connectors associated with an object, and a link between respective connectors of a pair of connected objects, each traversal proceeding according to a respective predetermined sequence;
logic configured to detect one of the assigned keystrokes entered on the keyboard; and
logic configured to associate a location cursor with one element of the group of objects, connectors, and link based on an existing association of the location cursor with one of the elements when the keystroke is detected and the predetermined sequence associated with the detected keystroke.

20. The system of claim 19, wherein when the detected keystroke is assigned to provide for traversing a plurality of connectable objects, the processor comprises:
logic configured to associate the location cursor with one of a next object, a previous object, a first object, and a last object in a left-to-right, top-to-bottom sequence of the connectable objects, the next and previous objects positioned in the representation relative to a position of the element associated with the location cursor when the keystroke is detected.

21. The system of claim 20, wherein the detected keystroke assigned to provide for associating the location cursor with the next, previous, first, and last objects in the sequence respectively comprises:
a Page-Down key or a Tab key;
a Page-Up key or a Shift-Tab key;
a Home key; and
an End key.

22. The system of claim 19, wherein when the detected keystroke is assigned to provide for traversing a plurality of connectable objects and the element associated with the location cursor when the keystroke is detected is a connector, the processor comprises:
logic configured to associate the location cursor with an object that includes the connector corresponding to the element associated with the location cursor when the keystroke is detected.

23. The system of claim 22, wherein the detected keystroke assigned to provide for associating the location cursor with the object that includes the connector comprises a Page-Down key, a Page-Up key, a Tab Key, or a Shift-Tab key.

24. The system of claim 19, wherein when the detected keystroke is assigned to provide for traversing a plurality of connectors associated with an object, the processor comprises:
logic configured to associate the location cursor with a connector in a perimetrical sequence of the connectors associated with the object based on whether the element associated with the location cursor when the keystroke is detected corresponds to the object or to a connector associated with the object.

25. The system of claim 24, wherein when the element associated with the location cursor when the keystroke is detected corresponds to the object, the processor comprises:
logic configured to associate the location cursor with a first connector in the sequence, the first connector positioned in the representation nearest a top-most portion of the object.

26. The system of claim 25, wherein the detected keystroke assigned to provide for associating the location cursor with the first connector in the sequence comprises a Right-Arrow key or a Left-Arrow key.

27. The system of claim 24, wherein when the element associated with the location cursor when the keystroke is detected corresponds to the connector associated with the object, the processor comprises:
logic configured to associate the location cursor with one of a next connector and a previous connector in the sequence, the next and previous connectors respectively positioned clockwise and counterclockwise in the sequence relative to a position in the representation of the connector associated with the object.

28. The system of claim 27, wherein the detected keystroke assigned to provide for associating the location cursor with the next connector in the sequence comprises a Right-Arrow key and the detected keystroke assigned to provide for associating the location cursor with the previous connector in the sequence comprises a Left-Arrow key.

29. The system of claim 19, wherein when the detected keystroke is assigned to provide for traversing a plurality of connectors associated with an object and the element associated with the location cursor when the keystroke is detected is a link between respective connectors of a pair of connected objects, the processor comprises:
logic configured to associate the location cursor with one of a first of the respective connectors, positioned in the representation either to the right of or below a center of the link, and a second of the connectors, positioned either to the left of or above the center of the link.

30. The system of claim 29, wherein the detected keystroke assigned to provide for associating the location cursor with the first connector comprises a Right-Arrow key and the detected keystroke assigned to provide for associating the location cursor with the second connector comprises a Left-Arrow key.

31. The system of claim 19, wherein when the detected keystroke is assigned to provide for traversing a link between respective connectors of a pair of connected objects, the processor comprises:
logic configured to associate the location cursor with one of the respective connectors when the element associated with the location cursor when the keystroke is detected corresponds to the link, and with the link when the element associated with the location cursor when the keystroke is detected corresponds to one of the respective connectors.

32. The system of claim 31, wherein when the element associated with the location cursor when the keystroke is detected corresponds to one of the respective connectors, the detected keystroke assigned to provide for associating the location cursor with the link comprises an Up-Arrow key or a Down-Arrow key.

33. The system of claim 32, wherein when the location cursor is associated with the link, the processor comprises:
logic configured to assign a same keystroke assigned to provide for associating the location cursor with the link to provide for associating the location cursor with the other of the respective connectors.

34. The system of claim 19, wherein the processor comprises:
logic configured to assign respective pairs of keystrokes to provide for separately traversing the plurality of connectable objects, the plurality of connectors, and the link;
wherein a first keystroke of a respective pair of keystrokes corresponds to the detected keystroke assigned to provide for associating the location cursor with the one element of the group of objects, connectors, and link, and a second keystroke of the respective pair is assigned to provide for re-associating the location cursor with the element associated with the location cursor when the keystroke is detected.

35. The system of claim 1, wherein the processor comprises:
logic configured to assign a keystroke to provide for selecting the one element of the group of objects, connectors, and link associated with the location cursor; and
logic configured to assign a keystroke to provide for performing an action on the one element of the group of objects, connectors, and link associated with the location cursor.

36. The system of claim 35, wherein the keystroke assigned to provide for selecting the one element comprises a Space-Bar key, and the keystroke assigned to provide for performing an action on the one element comprises an Enter key.

37. A computer readable medium containing a computer program of providing for keyboard navigation of a displayable representation of connectable objects, wherein the computer program comprises executable instructions for:
assigning keystrokes to provide for separately traversing a plurality of connectable objects included in the displayable representation, a plurality of connectors associated with an object, and a link between respective connectors of a pair of connected objects, each traversal proceeding according to a respective predetermined sequence;
detecting one of the assigned keystrokes; and
associating a location cursor with one element of the group of objects, connectors, and link based on an existing association of the location cursor with one of the elements when the keystroke is detected and the predetermined sequence associated with the detected keystroke.

38. The computer readable medium of claim 37, wherein when the detected keystroke is assigned to provide for traversing a plurality of connectable objects, the computer program comprises executable instructions for:
associating the location cursor with one of a next object, a previous object, a first object, and a last object in a left-to-right, top-to-bottom sequence of the connectable objects, the next and previous objects positioned in the representation relative to a position of the element associated with the location cursor when the keystroke is detected.

39. The computer readable medium of claim 37, wherein when the detected keystroke is assigned to provide for traversing a plurality of connectable objects and the element associated with the location cursor when the keystroke is detected is a connector, the computer program comprises executable instructions for:
associating the location cursor with an object that includes the connector corresponding to the element associated with the location cursor when the keystroke is detected.

40. The computer readable medium of claim 37, wherein when the detected keystroke is assigned to provide for traversing a plurality of connectors associated with an object, the computer program comprises executable instructions for:
associating the location cursor with a connector in a perimetrical sequence of the connectors associated with the object based on whether the element associated with the location cursor when the keystroke is detected corresponds to the object or to a connector associated with the object.

41. The computer readable medium of claim 40, wherein when the element associated with the location cursor when the keystroke is detected corresponds to the object, the computer program comprises executable instructions for:
associating the location cursor with a first connector in the sequence, the first connector positioned in the representation nearest a top-most portion of the object.

42. The computer readable medium of claim 40, wherein when the element associated with the location cursor when the keystroke is detected corresponds to the connector associated with the object, the computer program comprises executable instructions for:
associating the location cursor with one of a next connector and a previous connector in the sequence, the next and previous connectors respectively positioned clockwise and counterclockwise in the sequence relative to a position in the representation of the connector associated with the object.

43. The computer readable medium of claim 37, wherein when the detected keystroke is assigned to provide for traversing a plurality of connectors associated with an object and the element associated with the location cursor when the keystroke is detected is a link between respective connectors of a pair of connected objects, the computer program comprises executable instructions for:
associating the location cursor with one of a first of the respective connectors, positioned in the representation either to the right of or below a center of the link, and a second of the connectors, positioned either to the left of or above the center of the link.

44. The computer readable medium of claim 37, wherein when the detected keystroke is assigned to provide for traversing a link between respective connectors of a pair of connected objects, the computer program comprises executable instructions for:
associating the location cursor with one of the respective connectors when the element associated with the location cursor when the keystroke is detected corresponds to the link, and with the link when the element associated with the location cursor when the keystroke is detected corresponds to one of the respective connectors.

45. The computer readable medium of claim 44, wherein when the location cursor is associated with the link, the computer program comprises executable instructions for:
assigning a same keystroke assigned to provide for associating the location cursor with the link to provide for associating the location cursor with the other of the respective connectors.

46. The computer readable medium of claim 37, wherein the computer program comprises executable instructions for:
assigning respective pairs of keystrokes to provide for separately traversing the plurality of connectable objects, the plurality of connectors, and the link;
wherein a first keystroke of a respective pair of keystrokes corresponds to the detected keystroke assigned to provide for associating the location cursor with the one element of the group of objects, connectors, and link, and a second keystroke of the respective pair is assigned to provide for re-associating the location cursor with the element associated with the location cursor when the keystroke is detected.

47. The computer readable medium of claim 37, wherein the computer program comprises executable instructions for:
assigning a keystroke to provide for selecting the one element of the group of objects, connectors, and link associated with the location cursor; and
assigning a keystroke to provide for performing an action on the one element of the group of objects, connectors, and link associated with the location cursor.

48. A system of providing for keyboard navigation of a displayable representation of connectable objects, the system comprising:
means for displaying the representation of connectable objects;
means for generating signals corresponding to keystrokes entered on a keyboard;
means for assigning keystrokes to provide for separately traversing a plurality of connectable objects included in the displayable representation, a plurality of connectors associated with an object, and a link between respective connectors of a pair of connected objects, each traversal proceeding according to a respective predetermined sequence;
means for detecting one of the assigned keystrokes; and
means for associating a location cursor with one element of the group of objects, connectors, and link based on an existing association of the location cursor with one of the elements when the keystroke is detected and the predetermined sequence associated with the detected keystroke.
